(19) United States
(12) Patent Application Publication
(10) Pub. No.: US 2009/0206799 A1
(43) Pub. Date: Aug. 20, 2009

(54) Power Supply System for a Portable Electronic Device and Related Device and Method

(76) Inventor: Cho-Pin Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/350,215

(22) Filed: Jan. 7, 2009

(30) Foreign Application Priority Data
Feb. 18, 2008 (TW) 097105639

(51) Int. Cl. H02J 7/04; H02J 7/00

(52) U.S. Cl. 320/150; 320/137; 320/162

(57) ABSTRACT

A power supply system for a portable electronic device includes a rechargeable battery capable of being coupled to the portable electronic device by insertion for providing operating power for the portable electronic device, a storage device installed in the rechargeable battery, and a recharging device installed in the portable electronic device for charging the rechargeable battery and storing corresponding usage status data into the storage device when the rechargeable battery is coupled to the portable electronic device.

### BACKGROUND OF THE INVENTION

1. Field of the Invention

The present invention relates to a power supply system for a portable electronic device and related device and method, and more particularly, to a power supply system, related device and method capable of correctly charging a rechargeable battery in order to extend the lifetime of the rechargeable battery.

2. Description of the Prior Art

With technology development and industry progress, portable electronic devices, such as notebooks, mobile phones, cameras and MP3 players, are used more and more frequently in daily life. To facilitate a user to carry a portable electronic device, the portable electronic device is equipped with a rechargeable battery for providing operating power.

The rechargeable battery is an energy storage device capable of charging and discharging repetitively, so that the user can store power in the rechargeable battery through a charger. However, different users may have different usage habits and different using time. Thus, rechargeable batteries of the same model may have different lifetimes due to different users. For example, in case a user A charges a rechargeable battery while the rechargeable battery is about run out, and a user B charges a rechargeable battery of the same model after the rechargeable battery is utilized. In such a situation, the lifetimes of the rechargeable batteries utilized by the users A and B are quite different. Besides, if the same rechargeable battery is utilized for several identical portable electronic devices or several identical rechargeable batteries are utilized for the same portable electronic device, there will be different influence on the lifetime of the rechargeable batteries.

Therefore, in order to extend the lifetime of a rechargeable battery, the prior art records usage data of the rechargeable battery in the portable device, such as charging time, discharging time, etc. However, such method is only suitable for single portable electronic device with single rechargeable battery. If the user replaces the rechargeable battery or takes the rechargeable battery to other portable electronic device, it may result in errors of the recorded usage data, and affect the lifetime of the rechargeable battery.

### SUMMARY OF THE INVENTION

It is therefore a primary objective of the claimed invention to provide a power supply system for a portable electronic device and related device and method.

The present invention discloses a power supply system for a portable electronic device, which comprises a rechargeable battery capable of being coupled to the portable electronic device by insertion for providing operating power for the portable electronic device, a storage device installed in the rechargeable battery, and a recharging device installed in the portable electronic device for charging the rechargeable battery and storing corresponding usage status data into the storage device when the rechargeable battery is coupled to the portable electronic device.

The present invention further discloses a portable electronic device, which comprises a control system for implementing functions of the portable electronic device, and a power supply system coupled to the control system for providing power for the control system, wherein the power supply system comprises a rechargeable battery capable of being coupled to the portable electronic device by insertion for providing operating power for the control system, a storage device installed in the rechargeable battery, and a recharging device for charging the rechargeable battery and storing corresponding usage status data into the storage device when the rechargeable battery is coupled to the portable electronic device.

The present invention further discloses a recharging method for a portable electronic device, the portable electronic device capable of being coupled to a rechargeable battery by insertion, the rechargeable battery comprising a storage device for storing usage status data, the method comprises receiving the usage status data stored in the storage device when the rechargeable battery is coupled to the portable electronic device, charging the rechargeable battery according to the usage status data stored in the storage device, and updating the usage status data stored in the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power supply system for a portable electronic device according to an embodiment of the present invention.

FIG. 2 is a schematic diagram of a portable electronic device according to an embodiment of the present invention.

FIG. 3 is a schematic diagram of a recharging procedure for a portable electronic device according to an embodiment of the present invention.

### DETAILED DESCRIPTION

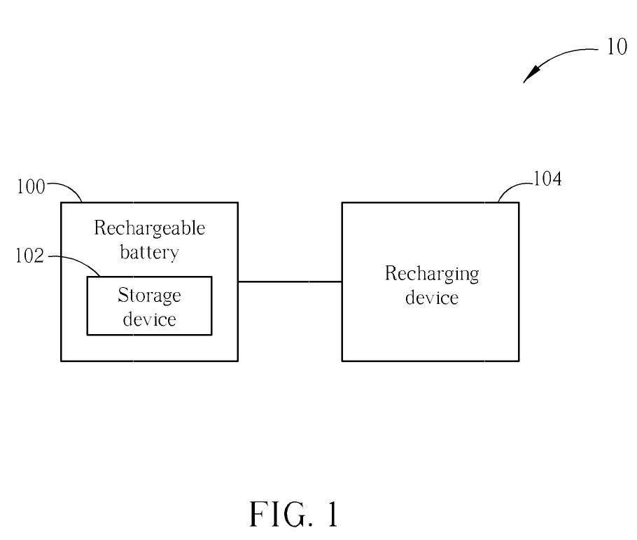

Please refer to FIG. 1. FIG. 1 is a schematic diagram of a power supply system 10 for a portable electronic device according to an embodiment of the present invention. The portable electronic device can be a notebook, a mobile phone, a camera, an MP3 player, etc. The power supply system 10 includes a rechargeable battery 100, a storage device 102 and a recharging device 104. The rechargeable battery 100 is utilized for providing operating power for the portable electronic device. When the rechargeable battery 100 is coupled to the portable electronic device, the recharging device 104 charges the rechargeable battery 100 and stores corresponding usage status data into the storage device 102. Since the storage device 102 is installed inside the rechargeable battery 100, the usage status data stored in the storage device 102 is corresponding to the rechargeable battery 100. In such a situation, the portable electronic device is capable of charging the rechargeable battery 100 according to the usage status data stored in the storage device 102 in order to extend the lifetime of the rechargeable battery 100.

FIG. 1 is a block diagram of the power supply system 10, and those skilled in the art can make alternations and modifications accordingly. For example, the recharging device 104 can be further coupled to an external power slot for receiving external power, such as AC power, and transforming the external power into proper voltage in order to charge the rechargeable battery 100. Certainly, the recharging device 104 can be a mechanical energy transformation device or an optical energy transformation device, utilized for generating power by means of energy transformation, in order to charge the rechargeable battery 100. As long as a recharging device can charge the rechargeable battery 100 and store the corresponding usage status data into the storage device 102, the recharging device can implement the recharging device 104, and be applied to the power supply system 10.

In addition, the rechargeable battery 100 and the storage device 102 are not limited in any mode or kind. The usage status data stored in the storage device 102 can be changed according to different requirements, and can include initial usage time, charging time, discharging time, the number of over heat alarms, the number of over current alarms, etc., which are not limitation of the present invention.

Therefore, via the power supply system 10, the present invention can store the usage status data of the rechargeable battery 100 into the storage device 102. Since the storage device 102 is installed inside the rechargeable battery 100, the usage status data of the rechargeable battery 100 will not be changed while the rechargeable battery 100 is utilized in different portable electronic devices, such that the portable electronic device is capable of charging the rechargeable battery 100 correctly according to the usage status data stored in the storage device 102 in order to extend the lifetime of the rechargeable battery 100.

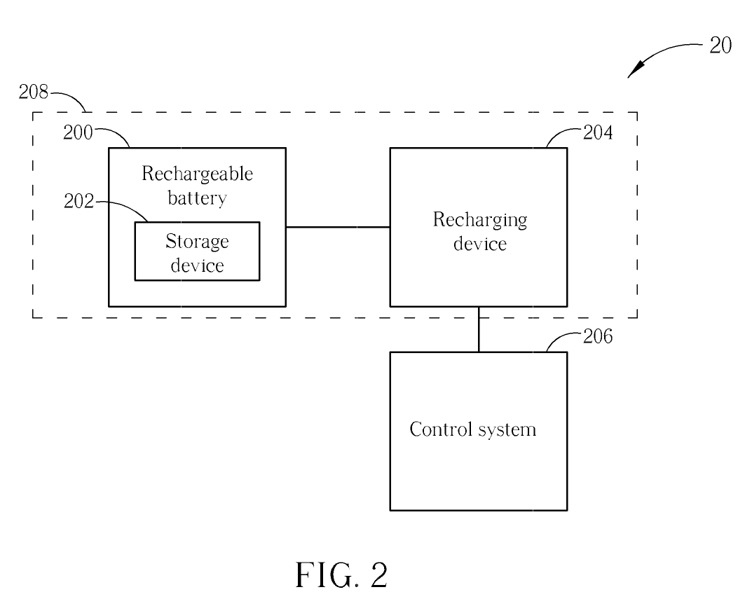

As to the operating method of the power supply system 10 used in a portable electronic device, please refer to FIG. 2. FIG. 2 is a schematic diagram of a portable electronic device 20 according to an embodiment of the present invention. The portable electronic device 20 can be a notebook, a mobile phone, a camera, an MP3 player, etc. The portable electronic device 20 includes a control system 206 and a power supply system 208. The power supply system 208 includes a rechargeable battery 200, a storage device 202 and a recharging device 204, and is the same as the power supply system 10 shown in FIG. 1, so that the details are omitted herein for the sake of brevity. The control system 206 is utilized for implementing functions of the portable electronic device 20, and preferably controls the recharging device 204 to charge the rechargeable battery 200 according to the usage status data stored in the storage device 202 of the rechargeable battery 200.

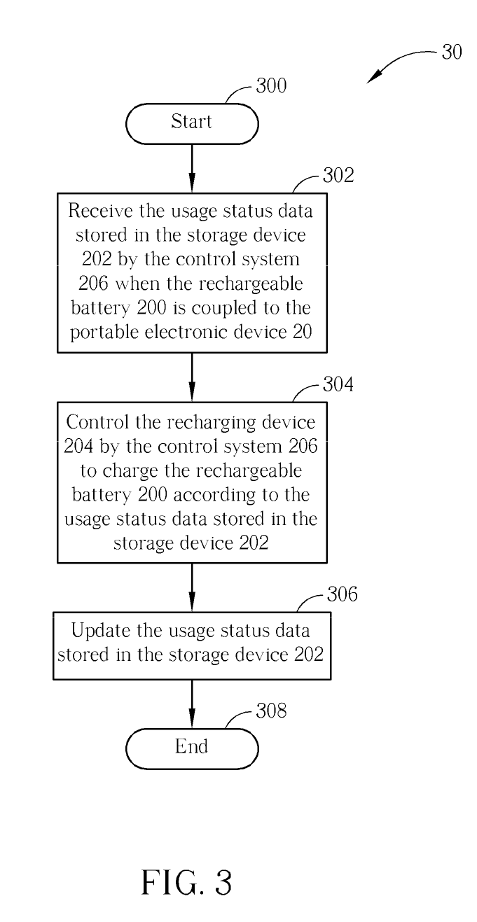

Please refer to FIG. 3, which is a schematic diagram of a recharging procedure 30 for the portable electronic device 20 according to an embodiment of the present invention. The recharging procedure 30 comprises the following steps:

Step 300: Start.

Step 302: Receive the usage status data stored in the storage device 202 by the control system 206 when the rechargeable battery 200 is coupled to the portable electronic device 20.

Step 304: Control the recharging device 204 by the control system 206 to charge the rechargeable battery 200 according to the usage status data stored in the storage device 202.

Step 306: Update the usage status data stored in the storage device 202.

Step 308: End.

According to the procedure 30, when the rechargeable battery 200 is coupled to the portable electronic device 20, the control system 206 receives the usage status data stored in the storage device 202, controls the recharging device 204 to charge the rechargeable battery 200, and updates the usage status data stored in the storage device 202. In short, the control system 206 can adjust the recharging operation of the rechargeable battery 200 according to the usage status data stored in the storage device 202. Since the storage device 202 is installed in the rechargeable battery 200, the usage status data of the rechargeable battery 200 will not be changed when the rechargeable battery 200 is utilized for different portable electronic devices, such that the portable electronic device 20 is capable of charging the rechargeable battery 200 correctly according to the usage status data stored in the storage device 202 in order to extend the lifetime of the rechargeable battery 200.

Note that, the procedure 30 is an exemplary embodiment of the present invention, and those skilled in the art can make alternations and modifications accordingly. For example, in case the rechargeable battery 200 is used for the first time, the initial usage time of the rechargeable battery 200 can be recorded in the storage device 202 as validation of warranty. Furthermore, charging time, discharging time, the number of over heat alarms, the number of over current alarms or other data corresponding to the rechargeable battery 200 can also be recorded, in order to control the recharging operation of the rechargeable battery 200.

In conclusion, the present invention can store the usage status data of the rechargeable battery into the storage device installed in the rechargeable battery, such that the usage status data of the rechargeable battery will not be changed when the rechargeable battery is utilized in different portable electronic devices. Therefore, the portable electronic device can charge the rechargeable battery correctly according to the usage status data stored in the storage device in order to extend the lifetime of the rechargeable battery.

Those skilled in the art will readily observe that numerous modifications and alterations of the device and method may be made while retaining the teachings of the invention.

What is claimed is:

1. A power supply system for a portable electronic device comprising:
a rechargeable battery capable of being coupled to the portable electronic device by insertion for providing operating power for the portable electronic device;
a storage device installed in the rechargeable battery; and
a recharging device installed in the portable electronic device for charging the rechargeable battery and storing corresponding usage status data into the storage device when the rechargeable battery is coupled to the portable electronic device.

2. The power supply system of claim 1 further comprising an external power slot for receiving external power.

3. The power supply system of claim 1, wherein the recharging device is coupled to the external power slot for transforming the external power in order to charge the rechargeable battery.

4. The power supply system of claim 1, wherein the usage status data comprises initial usage time of the rechargeable battery.

5. The power supply system of claim 1, wherein the usage status data comprises charging time and discharging time of the rechargeable battery.

6. The power supply system of claim 1, wherein the usage status data comprises the number of over heat alarms of the rechargeable battery.

7. The power supply system of claim 1, wherein the usage status data comprises the number of over current alarms of the rechargeable battery.

8. A portable electronic device comprising:
a control system for implementing functions of the portable electronic device; and
a power supply system coupled to the control system for providing power for the control system, wherein the power supply system comprises:
a rechargeable battery capable of being coupled to the portable electronic device by insertion for providing operating power for the control system;
a storage device installed in the rechargeable battery; and
a recharging device for charging the rechargeable battery and storing corresponding usage status data into the storage device when the rechargeable battery is coupled to the portable electronic device.

9. The portable electronic device of claim 8 further comprising an external power slot for receiving power.

10. The portable electronic device of claim 8, wherein the recharging device is coupled to the external power slot for transforming the external power in order to charge the rechargeable battery.

11. The portable electronic device of claim 8, wherein the control system is further coupled to the recharging device for controlling the operating method of charging the rechargeable battery by recharging device according to the usage status data.

12. The portable electronic device of claim 8, wherein the usage status data comprises initial usage time of the rechargeable battery.

13. The portable electronic device of claim 8, wherein the usage status data comprises charging time and discharging time of the rechargeable battery.

14. The portable electronic device of claim 8, wherein the usage status data comprises the number of over heat alarms of the rechargeable battery.

15. The portable electronic device of claim 8, wherein the usage status data comprises the number of over current alarms of the rechargeable battery.

16. A recharging method for a portable electronic device, the portable electronic device capable of being coupled to a rechargeable battery by insertion, the rechargeable battery comprising a storage device for storing usage status data, the method comprising:
receiving the usage status data stored in the storage device when the rechargeable battery is coupled to the portable electronic device;
charging the rechargeable battery according to the usage status data stored in the storage device; and
updating the usage status data stored in the storage device.

17. The recharging method of claim 16, wherein updating the usage status data stored in the storage device is storing initial usage time of the corresponding rechargeable battery in the storage device when the rechargeable battery is used for the first time.

18. The recharging method of claim 16, wherein updating the usage status data stored in the storage device is storing charging time and discharging time of the corresponding rechargeable battery in the storage device.

19. The recharging method of claim 16, wherein updating the usage status data stored in the storage device is storing the number of over heat alarms of the corresponding rechargeable battery in the storage device.

20. The recharging method of claim 16, wherein updating the usage status data stored in the storage device is storing the number of over current alarms of the corresponding rechargeable battery in the storage device.
